(19) United States
(12) Patent Application Publication
(10) Pub. No.: US 2007/0054191 A1
(43) Pub. Date: Mar. 8, 2007

(54) Non- aqueous electrolyte secondary battery

(76) Inventors: Takayuki Shirane, Osaka (JP); Takashi Takeuchi, Osaka (JP); Takaya Saito, Tochigi (JP); Atsushi Ueda, Osaka (JP)

Correspondence Address: MCDERMOTT WILL & EMERY LLP, 600 13TH STREET, N.W., WASHINGTON, DC, 20005-3096, US

(21) Appl. No.: 11/513,234

(22) Filed: Aug. 31, 2006

(30) Foreign Application Priority Data
Sep. 2, 2005 (JP) 2005-254779

(51) Int. Cl. H01M 4/52; H01M 4/50

(52) U.S. Cl. 429/223; 429/231.3; 429/224

(57) ABSTRACT

A non-aqueous electrolyte secondary battery including a positive electrode containing a positive electrode active material, a negative electrode containing a negative electrode active material, a separator and a non-aqueous electrolyte, wherein the positive electrode active material includes a nickel-containing composite oxide represented by the following formula (1):
Li_{d}(NiₐMn_{b}Co_{1-a-b})_{1-c}L_{c}O₂, where 0.1≦a≦0.5, 0.2≦b≦0.4, 0.003<c≦0.05, 1≦d≦1.05, and L is at least one selected from the group consisting of Y, Zr and Mo.

### FIELD OF THE INVENTION

The present invention relates to a non-aqueous electrolyte secondary battery, and more particularly to an improvement of a positive electrode active material.

### BACKGROUND OF THE INVENTION

Non-aqueous electrolyte secondary batteries have a high electromotive force and a high energy density. Accordingly, they are used as power sources for driving electronic devices such as mobile communication devices and personal computers. As more functionality is added to such electronic devices in recent years, demand is growing for non-aqueous electrolyte secondary batteries having a high capacity and long life.

As the positive electrode active material for non-aqueous electrolyte secondary batteries, lithium cobalt composite oxides such as LiCoO₂ are usually employed. In addition to lithium cobalt composite oxides, the following compounds are also employed, for example: lithium nickel composite oxides such as LiNiO₂, lithium manganese composite oxide such as LiMn₂O₄ and LiMnO₂, their mixtures and solid solutions prepared by introducing a certain element to the composite oxides listed above.

Among these positive electrode active materials, lithium nickel oxide (LiNiO₂) is the most promising candidate for achieving high capacity. Lithium nickel oxide, however, has low thermal stability during charge, and because its crystal structure changes during charge, lithium nickel oxide has short life. Lithium manganese oxide (LiMn₂O₄), on the other hand, has excellent thermal stability during charge, but its capacity per weight is small. Moreover, when a battery containing lithium manganese oxide is exposed to high temperature for a long period of time, manganese leaches out from the lithium manganese oxide, which can significantly degrade the charge/discharge characteristics.

In light of the above, lithium-nickel/cobalt/manganese composite oxide (Li(NiCoMn)O₂) having a high capacity and a good balance of various characteristics has been examined. Specifically, in order to improve life characteristics of Li(NiCoMn)O₂, LiNiₓ(CoMnM)₁₋ₓO₂ solid solution (x≧0.5) in which an element M such as Y, Al, Fe or Cu is introduced is proposed (see, e.g., Japanese Laid-Open Patent Publication No. Hei 10-199525). In this publication, the element M acts to prevent manganese from leaching out from LiNiₓ(CoMnM)₁₋ₓO₂.

While investigating high capacity active materials, proposals are also made to improve battery capacity by increasing end-of-charge voltage. To increase end-of-charge voltage, it is preferred to improve materials for use in the positive and negative electrodes. For example, Japanese Laid-Open Patent Publication No. 2001-351624 proposes a solid solution prepared by introducing an element such as Ti, Ni, Mn or Y into lithium cobalt oxide, so that the lithium cobalt oxide can be used without causing any problem even when it is charged to a high end-of-charge voltage. Inclusion of the element in lithium cobalt oxide solid solution stabilizes its crystal structure and improves the life characteristics. Although not specifically explained in Japanese Laid-Open Patent Publication No. 2001-351624, it is presumed that the element acts to prevent the structural change of LiCoO₂ due to intercalation of Li during charge and to prevent LiCoO₂ from becoming unstable thereby.

When a battery is charged and discharged, a difference can occur between the initial charge capacity and the initial discharge capacity (herein after referred to as irreversible capacity) in both positive and negative electrodes depending on the active materials used. When the irreversible capacity of the positive electrode exceeds that of the negative electrode, unused lithium in an amount equal to the difference between the irreversible capacity of the positive electrode and that of the negative electrode is left in the negative electrode. For this reason, the battery capacity decreases. This phenomenon becomes more pronounced as the ratio of Ni contained in the positive electrode active material is increased.

In order to reduce the irreversible capacity of the positive electrode relative to that of the negative electrode, a positive electrode active material comprising a Li(NiCoMn)O₂-based composite oxide having a small amount of nickel is proposed. However, even if a solid solution prepared by introducing a certain element into a Li(NiCoMn)O₂-based composite oxide is used as disclosed by Japanese Laid-Open Patent Publication No. Hei 10-199525, when the end-of-charge voltage is increased, manganese leaches out from the solid solution. Accordingly, desired life characteristics cannot be obtained.

The present invention has been made to address the above problem. It is an object of the present invention to provide a non-aqueous electrolyte secondary battery comprising a Li(NiCoMn)O₂-based composite oxide having a small amount of nickel in which even when the end-of-charge voltage is increased, high capacity and excellent life characteristics can be achieved.

### BRIEF SUMMARY OF THE INVENTION

As a result of extensive and thorough research, the present inventors obtained the following findings.

(1) When the end-of-charge voltage is increased and the molar ratio of nickel is 0.1 to 0.5 relative to the total of nickel, manganese and cobalt contained in a Li(NiCoMn)O₂-based composite oxide, although the reason is unclear, the leaching of manganese into a non-aqueous electrolyte is prevented sufficiently even if the amount of a certain element incorporated into the Li(NiCoMn)O₂-based composite oxide is small.

(2) When the amount of a certain element incorporated into the Li(NiCoMn)O₂-based composite oxide is large, part of the element cannot incorporate into the structure of the composite oxide, and the unincorporated element exists as an impurity in the form of an oxide in the composite oxide. Such impurity acts to reduce, although slightly, the true potential of the positive electrode. Namely, when a battery is charged to a specified end-of-charge voltage, even if the apparent potential of the positive electrode corresponds to the end-of-charge voltage, the potential of the area where the impurity exists is high. Because the potential increases locally as described above, the leaching of manganese cannot be prevented.

The present invention has been accomplished on the basis of these findings, and provides a non-aqueous electrolyte secondary battery comprising, as the positive electrode active material, a solid solution of a Li(NiCoMn)O₂-based composite oxide containing a certain element dissolved therein, wherein high capacity and excellent life characteristics is achieved by adjusting the amount of the certain element according to the amount of nickel contained in the solid solution even when the end-of-charge voltage is increased.

To be more specific, the present invention relates to a non-aqueous electrolyte secondary battery comprising a positive electrode including a positive electrode active material, a negative electrode including a negative electrode active material, a separator and a non-aqueous electrolyte, wherein the positive electrode active material comprises a nickel-containing composite oxide represented by the following formula (1):
Li_{d}(NiₐMn_{b}Co_{1-a-b})_{1-c}L_{c}O₂,
where 0.1≦a≦0.5, 0.2≦b≦0.4, 0.003≦c≦0.05, 1≦d≦1.05, and L is at least one selected from the group consisting of Y, Zr and Mo.

Preferably, the positive electrode active material further comprises a magnesium-containing composite oxide represented by the following formula (2):
Li_{d}Co₁₋ₓMgₓO₀₂,
where 0.005≦x≦0.1 and 1≦d≦1.05.

More preferably, the weight A of the nickel-containing composite oxide and the weight B of the magnesium-containing composite oxide satisfy the following relation:
0.3≦A/(A+B)≦0.5.

The present invention further relates to a system comprising the above-described non-aqueous electrolyte secondary battery and a charger for charging the non-aqueous electrolyte secondary battery, wherein the end-of-charge voltage in the charger is set to 4.25 to 4.50 V.

While the novel features of the invention are set forth particularly in the appended claims, the invention, both as to organization and content, will be better understood and appreciated, along with other objects and features thereof, from the following detailed description.

### DETAILED DESCRIPTION OF THE INVENTION

Embodiments of the present invention are explained in detail.

A non-aqueous electrolyte secondary battery of the present invention comprises, for example, an electrode group, a non-aqueous electrolyte and a battery case for housing the electrode group and the non-aqueous electrolyte. The electrode group comprises a positive electrode, a negative electrode and a separator interposed between the positive and negative electrodes.

The positive electrode comprises, for example, a positive electrode current collector and positive electrode active material layers carried on both surfaces of the current collector. The negative electrode comprises, for example, a negative electrode current collector and negative electrode active material layers carried on both surfaces of the current collector.

The positive electrode active material layer comprises, for example, a positive electrode active material, a conductive material and a binder.

The positive electrode active material comprises a nickel-containing composite oxide represented by the following formula (1): Li_{d}(NiₐMn_{b}Co_{1-a-b})_{1-c}L_{c}O₂, where 0.1≦a≦0.5, 0.2≦b≦0.4, 0.003≦c≦0.05, 1d≦1.05, and L is at least one selected from the group consisting of Y, Zr and Mo. The nickel-containing composite oxide is a solid solution in which the element L is dissolved into a Li(NiCoMn)O₂-based oxide. In the formula (1), the ratio of each element is a value obtained immediately after the production of the nickel-containing composite oxide. The molar ratios of nickel, manganese, cobalt and the element L are considered not to vary by charge/discharge.

The nickel-containing composite oxide having a small amount of nickel as described above has a small irreversible capacity. Accordingly, the battery capacity can be increased. The end-of-charge voltage of the non-aqueous electrolyte secondary battery of the present invention is preferably 4.25 to 4.50 V. By increasing the end-of-charge voltage to the level as described above, the battery capacity can be further improved.

In a Li(NiCoMn)O₂-based oxide, manganese leaches out into the non-aqueous electrolyte during high voltage charge and during high temperature storage, which can significantly degrade the life characteristics and the storage characteristics. In order to cope with this, at least one element L selected from the group consisting of Y, Zr and Mo is incorporated into a Li(NiCoMn)O₂-based oxide, whereby the disproportionation of Mn is prevented in the crystal structure of the resulting nickel-containing composite oxide, and thus the leaching of manganese into the non-aqueous electrolyte can be prevented. As a result, the life characteristics of the battery can be improved.

Note that unless the amount of the element L is adjusted according to the amount of nickel as well as the amounts of elements other than nickel and the element L are adjusted properly, the above-described advantage of the present invention cannot be obtained.

Nickel (Ni) is contained in the nickel-containing composite oxide so as to increase the theoretical capacity. When the amount of nickel is too large, however, the irreversible capacity increases in the resulting battery. Moreover, as the charge depth increases, the structure of the active material becomes unstable, degrading the life characteristics. When the amount of nickel is small, the battery capacity cannot be increased. Accordingly, the molar ratio a of nickel to the total of nickel, cobalt and manganese needs to be 0.1≦a≦0.5, and preferably 0.2≦a≦0.4. Note that even if the amount of the element L is small, as long as the amount of nickel falls within the above range, the effect of preventing manganese from leaching out can be obtained.

Manganese (Mn) is contained in the nickel-containing composite oxide so as to prevent the expansion and contraction of the nickel-containing composite oxide during charge and discharge. When the amount of manganese is too large, however, even if the element L is added, the amount of leaching manganese increases, degrading the life characteristics. When the amount of manganese is small, the effect of preventing the nickel-containing composite oxide from expanding and contracting is difficult to obtain. Accordingly, the molar ratio b of manganese to the total of nickel, cobalt and manganese needs to be 0.2≦b≦0.4, and preferably 0.25≦b≦0.35.

The element L is contained in the nickel-containing composite oxide so as to prevent the leaching of manganese. When the amount of the element L is too large, however, a part of the element L exists as an impurity in the form of an oxide, decreasing the battery capacity. When the amount of the element L is small, the effect of preventing manganese from leaching out cannot be obtained. Accordingly, the molar ratio c of the element L to the total of nickel, manganese, cobalt and the element L needs to be 0.003≦c≦0.05.

Cobalt (Co) is contained in the nickel-containing composite oxide so as to stabilize the crystal structure. The amount of cobalt is preferably determined considering the balance of other elements contained in the nickel-containing composite oxide. In the nickel-containing composite oxide, the molar ratio of cobalt to the total of nickel, manganese and cobalt is adjusted to satisfy 1−a−b. When the amount of cobalt is too large, however, the theoretical capacity decreases.

In the nickel-containing composite oxide immediately after the preparation, the molar ratio d of lithium to the total of nickel, manganese, cobalt and the element L is preferably 1 to 1.05. When the amount of lithium is too large, the positive electrode current collector is corroded by the nickel-containing composite oxide, and the positive electrode active material layer(s) can be separated from the current collector, degrading the life characteristics.

The amount of lithium contained in the nickel-containing composite oxide varies during charge/discharge. During charge/discharge, the amount of lithium is preferably 0.3 to 1.1 atoms per atom of the transition metal, and more preferably 0.32 to 1.1 atoms. In other words, the molar ratio d of lithium is preferably 0.3 to 1.1, and more preferably 0.32 to 1.1. Thereby, the battery capacity can be increased. In addition, excess Li acts to prevent the substitution reaction of Li with Ni in the crystal structure of the positive electrode active material. The upper limit of the above-described lithium amount is the maximum value in the starting composition. The lower limit of the above-described lithium amount is an amount of lithium contained in the positive electrode active material when charged, for example, to 4.5 V.

The nickel-containing composite oxide containing the element L can be produced by various methods. For example, one method is to bake a hydroxide containing Ni, Mn and Co synthesized by coprecipitation with a lithium compound and a compound containing the element L. The lithium compound can be lithium carbonate, lithium hydroxide, etc. The compound containing the element L can be an oxide containing the element L.

Besides the above method, other methods may be employed. For example, a hydroxide containing Ni, Mn, Co and the element L synthesized by coprecipitation is baked with a lithium compound. Alternatively, a compound containing Ni, Mn, Co, Li and the element L is produced through solid phase reaction by directly baking a raw material mixture. The raw material mixture includes, for example, a nickel compound, a manganese compound, a cobalt compound and a compound containing the element L.

The leaching of manganese is considered to occur at the interface between the composite oxide and the non-aqueous electrolyte. Accordingly, among the methods for producing the nickel-containing composite oxide containing the element L described above, preferred is the method in which a hydroxide, a lithium compound and a compound containing the element L are baked together. It should be understood that even when the method in which a hydroxide containing the element L and a lithium compound are baked together or the method in which a raw material mixture is directly baked is employed, it is possible to obtain a nickel-containing composite oxide having stable internal crystal structure.

In the present invention, the positive electrode active material preferably comprises, in addition to the nickel-containing composite oxide, a magnesium-containing composite oxide represented by the following formula (2): Li_{d}Co₁₋ₓMgₓO₂, where 0.005≦x≦0.1 and 1≦d≦1.05. In this formula (2) also, the ratios of lithium and magnesium are values obtained immediately after the preparation of the magnesium-containing composite oxide. Similar to the above, during charge/discharge, the molar ratio d of lithium is preferably 0.3 to 1.1, and more preferably 0.32 to 1.1.

The nickel-containing composite oxide has a low true density. For this reason, it is difficult to increase the active material density of the positive electrode by using only the nickel-containing composite oxide. The combined use of the nickel-containing composite oxide with the manganese-containing composite oxide having a high true density can increase the active material density of the positive electrode.

In this case, it is more preferred that the weight A of the nickel-containing composite oxide and the weight B of the magnesium-containing composite oxide satisfy the following relation: 0.3≦A/(A+B)≦0.5.

By adjusting the mixing ratio of the magnesium-containing composite oxide having a high true density and the nickel-containing composite oxide having a high theoretical capacity but a low true density to fall within the above-described range, high capacity positive electrode can be obtained efficiently. When the ratio A/(A+B) is less than 0.3, the effect offered by the use of the nickel-containing composite oxide cannot be obtained. When the ratio A/(A+B) exceeds 0.5, because the amount of the nickel-containing composite oxide having a low true density increases, further improvement of positive electrode capacity cannot be obtained.

When the amount of Mg contained in the magnesium-containing composite oxide is too large, the theoretical capacity decreases. Accordingly, the molar ratio x of magnesium to the total of magnesium and cobalt is preferably 0.005≦x≦0.1, and more preferably 0.02≦x≦0.08.

As stated previously, the positive electrode active material layer can comprise, in addition to the positive electrode active material, a binder and a conductive material. The binder for the positive electrode is not specifically limited. Examples include polyvinylidene fluoride, polytetrafluoroethylene and a rubber particle binder containing an acrylonitrile unit (BM-500B (trade name) available from Zeon Corporation, Japan). When polytetrafluoroethylene or the rubber particle binder (BM-500B) is used as the binder in a positive electrode material mixture paste comprising an active material, a binder and a conductive material, a thickener is preferably added to the positive electrode material mixture paste. Examples of the thickener include carboxymethyl cellulose, polyethylene oxide and a water-soluble modified rubber containing an acrylonitrile unit (BM-720H (trade name) available from Zeon Corporation, Japan). The amount of the binder is preferably 0.1 to 5 parts by weight per 100 parts by weight of the positive electrode active material. The amount of the thickener is preferably 0.1 to 5 parts by weight per 100 parts by weight of the positive electrode active material.

The conductive material can be acetylene black, ketjen black or graphite. They may be used singly or in any combination of two or more. The amount of the conductive material is preferably 2 to 5 parts by weight per 100 parts by weight of the positive electrode active material, and usually 2 to 3 parts by weight.

The negative electrode active material layer can comprise, for example, a negative electrode active material and a binder. The negative electrode active material can be any natural graphite, any artificial graphite, a silicon-containing composite material or any alloy material.

The binder for the negative electrode is not specifically limited. For example, an elastic polymer containing a styrene unit and a butadiene unit can be used. Specific examples include styrene-butadiene copolymer (SBR) and acrylic acid-modified SBR. When a negative electrode material mixture paste containing an active material and a binder is used to produce the negative electrode, a thickener comprising a water-soluble polymer is preferably added to the paste. The water-soluble polymer is preferably a cellulose resin, and more preferably carboxymethyl cellulose. The amount of the binder is preferably 0.1 to 5 parts by weight per 100 parts by weight of the negative electrode active material. The amount of the thickener is preferably 0.1 to 5 parts by weight per 100 parts by weight of the negative electrode active material.

The positive and negative electrode current collectors can be, for example, foils made of material known in the field of battery technology. The material for the positive electrode current collector can be aluminum, for example. The material for the negative electrode current collector can be copper, for example.

The separator is preferably a microporous film comprising a resin having a melting point of not greater than 200° C. Among resins having a melting point of not greater than 200° C., particularly preferred are polyethylene, polypropylene, a mixture of polyethylene and polypropylene, and a copolymer of ethylene and propylene. By using a separator comprising a resin as listed above, even if an external short-circuit occurs, the separator in the battery melts, increasing resistance to battery reaction and reducing short-circuit current. Consequently, it is possible to prevent the battery from overheating and reaching an excessively high temperature. The thickness of the separator is preferably 10 to 40 μm from the viewpoint of ensuring the ion conductivity and maintaining the energy density.

The non-aqueous electrolyte comprises a non-aqueous solvent and a solute dissolved in the non-aqueous solvent. The non-aqueous solvent can be, but not limited to, ethylene carbonate, propylene carbonate, dimethyl carbonate, diethyl carbonate or methyl ethyl carbonate. The non-aqueous solvent may be used singly or in any combination of two or more.

The solute can be, for example, a lithium salt such as hexafluorophosphate (LiPF₆) or lithium tetrafluoroborate (LiBF₄).

In order to form a film suitable for ensuring stability in the event of overcharge on the surface of the positive electrode active material and/or the negative electrode active material, vinylene carbonate, cyclohexylbenzene or their derivative may be added to the non-aqueous electrolyte.

The non-aqueous electrolyte secondary battery of the present invention can be produced as follows, for example.

An electrode group is produced by spirally winding a positive electrode including the positive electrode active material and a negative electrode with a separator interposed therebetween. The obtained electrode group is housed into a battery case, to which a non-aqueous electrolyte is injected. The opening of the battery case is sealed with a sealing plate to produce a battery.

When the battery is a cylindrical battery, the electrode group has a substantially circular transverse cross section, and the battery case can be a cylindrical battery case, for example. When the battery is a prismatic battery, the electrode group has a substantially rectangular transverse cross section, and the battery case can be a prismatic battery case, for example. In this case, a laminate-type electrode group in which positive and negative electrode sheets are laminated with a separator sheet interposed therebetween may be used.

As stated previously, in the non-aqueous electrolyte secondary battery of the present invention, the end-of-charge voltage is preferably set to 4.25 to 4.50 V, and more preferably 4.25 to 4.4 V. In other words, in a system comprising the non-aqueous electrolyte secondary battery of the present invention and a charger for charging the battery, the end-of-charge voltage in the charger is preferably set to 4.25 to 4.50 V, and more preferably 4.25 to 4.4 V. When the end-of-charge voltage is lower than 4.25 V, the advantage of improving the capacity of positive electrode offered by the use of the nickel-containing composite oxide cannot be obtained. When the end-of-charge voltage is higher than 4.50 V, the non-aqueous electrolyte is decomposed by oxidation, causing depletion of electrolyte. The depletion of electrolyte generates gases and causes the cycle characteristics to degrade.

The present invention will be described below with reference to examples. In the examples given below, cylindrical batteries having an electrode group of spirally wound design are produced. However, the battery shape is not limited thereto. The present invention is also applicable to, for example, prismatic batteries having an electrode group of spirally wound design or laminate design. Additionally, it should be understood that the present invention is not limited to the examples given below.

### EXAMPLE 1

(Comparative Battery A)

(i) Production of Positive Electrode

Lithium cobalt oxide (LiCoO₂) was used as a positive electrode active material. Lithium cobalt oxide was prepared in the following manner.

A mixture was prepared by mixing cobalt oxide and lithium carbonate such that the molar ratio (Li/Co) of Li to Co was 1.1. The mixture was baked at 900° C. for 24 hours. Thereby, lithium cobalt oxide was obtained.

The positive electrode active material in an amount of 100 parts by weight was mixed with 3 parts by weight of acetylene black as a conductive material and 4 parts by weight of polyvinylidene fluoride as a binder. Then, N-methyl-2-pyrrolidone (NMP) as a dispersing medium was added to the resulting mixture, and the mixture was uniformly dispersed in the dispersing medium. Thereby, a positive electrode material mixture paste was prepared.

The obtained paste was applied onto both surfaces of a 15 μm thick aluminum (Al) foil serving as a positive electrode current collector. The paste layers applied onto both surfaces of the positive electrode current collector were dried and rolled to produce a positive electrode plate. The resulting positive electrode plate had a thickness of 150 μm, and the positive electrode active material layers each had a density of 3.3 g/cm³.

The obtained positive electrode plate was cut into a size of 57 mm width and 656 mm length. Thereby, a positive electrode was produced. An end of a positive electrode lead made of aluminum (Al) was welded to an exposed portion of current collector having a width of 57 mm and a length of 30 μm formed in the part of the positive electrode at the initial winding side which would not face a negative electrode.

(ii) Production of Negative Electrode

A negative electrode material mixture paste was prepared by mixing 100 parts by weight of graphite as a negative electrode active material, 3 parts by weight of styrene-butadiene rubber (SBR) as a binder and an appropriate amount of an aqueous solution containing carboxymethyl cellulose as a thickener. The aqueous solution containing carboxymethyl cellulose was added such that the amount of carboxymethyl cellulose was 1 part by weight per 100 parts by weight of the negative electrode active material.

The obtained paste was applied onto both surfaces of a 10 μm thick copper (Cu) foil serving as a negative electrode current collector. The paste layers applied onto both surfaces of the negative electrode current collector were dried and rolled to produce a negative electrode plate. The resulting negative electrode plate had a thickness of 153 μm, and the negative electrode active material layers each had a density of 1.4 g/cm³.

The obtained negative electrode plate was cut into a size of 59 mm width and 698 mm length. Thereby, a negative electrode was produced. An end of a negative electrode lead made of nickel (Ni) was welded to an exposed portion of current collector having a width of 59 mm and a length of 5 μm formed in the part of the negative electrode at the final winding side which would not face the positive electrode.

(iii) Production of Battery

A cylindrical electrode group was produced by spirally winding the positive and negative electrodes produced above with a separator therebetween. In this process, the positive and negative electrodes were placed such that the upper and lower edges (in the width direction) of the positive electrode active material layer were positioned 1 mm inside from the upper and lower edges (in the width direction) of the negative electrode active material layer in the resulting electrode group. The positive electrode lead was in the top portion of the electrode group, and the negative electrode lead was in the bottom portion of the same.

The obtained electrode group was inserted into a cylindrical battery case having one opening. The battery case used here was an iron case plated with nickel having a diameter of 18 mm and a height of 65 mm.

Between the battery case and the bottom of the electrode group was disposed a lower insulating plate. The other end of the negative electrode lead was welded to the bottom of the battery case. On the top portion of the battery case having the opening was formed a groove for fixing sealing plate. On the top of the electrode group was placed an upper insulating plate. The other end of the positive electrode lead was welded to a sealing plate.

The battery still in the production process was dried at 60° C. in a vacuum. Thereafter, 5.8 g of non-aqueous electrolyte was injected. The non-aqueous electrolyte used here was prepared by dissolving LiPF₆ in a solvent mixture of ethylene carbonate, dimethyl carbonate and ethyl methyl carbonate at a volume ratio of 2:3:3 at a LiPF₆ concentration of 1.0 mol/L.

Subsequently, the opening of the battery case was sealed by crimping the opening end of the battery case onto the sealing plate.

The obtained battery was charged at a current of 400 mA until the battery voltage reached 4.1 V, and then discharged at a current of 400 mA until the battery voltage decreased to 2.5 V. This charge/discharge cycle was repeated three times.

The battery produced in the above-described manner was denoted as comparative battery A.

(Comparative Battery B)

A comparative battery B was produced in the same manner as the comparative battery A was produced except that Li(Ni_{0.05}Mn_{0.2}Co_{0.75})_{0.95}Y_{0.05}O₂ was used as the positive electrode active material. In the comparative battery B, the density of the positive electrode active material layers was 3.2 g/cm³. The positive electrode had a thickness of 142 μm and a length of 652 mm. The negative electrode had a length of 694 mm.

Li(Ni_{0.05}Mn_{0.2}Co_{0.75})_{0.95}YO_{0.05}O₂ was prepared as follows.

A precipitate was formed by adding alkali to an aqueous solution of sulfuric acid salt containing nickel (Ni), manganese (Mn) and cobalt (Co) at a molar ratio of 0.5:2:7.5. This precipitate was filtered, which was then washed with water and dried, forming a hydroxide. The obtained hydroxide was mixed with lithium carbonate and Y₂O₃ at a specified ratio. Y₂O₃ was added such that the ratio of Y to the total amount of the transition metals contained in the hydroxide and Y was 5 mol %. The resulting mixture was baked at 900° C. for 24 hours. Thereby, Li(Ni_{0.05}Mn_{0.2}Co_{0.75})_{0.95}Y_{0.05}O₂ was synthesized.

(Comparative Battery C)

A positive electrode active material having a composition represented by Li(Ni_{0.55}Mn_{0.2}Co_{0.25})_{0.95}Y_{0.05}O₂ was prepared in the same manner as that of the comparative battery B was prepared except that the molar ratio of Ni, Mn and Co contained in the aqueous solution of sulfuric acid salt was changed to 5.5:2:2.5. Using this positive electrode active material, a comparative battery C was produced in the same manner as the comparative battery B was produced. In the comparative battery C, the density of the positive electrode active material layers was 3.1 g/cm³. The positive electrode had a thickness of 125 μm and a length of 680 mm. The negative electrode had a length of 722 mm.

(Comparative Battery D)

A positive electrode active material having a composition represented by Li(Ni_{0.1}Mn_{0.1}Co_{0.8})_{0.95}Y_{0.05}O₂ was prepared in the same manner as that of the comparative battery B was prepared except that the molar ratio of Ni, Mn and Co contained in the aqueous solution of sulfuric acid salt was changed to 1:1:8. Using this positive electrode active material, a comparative battery D was produced in the same manner as the comparative battery B was produced. In the comparative battery D, the density of the positive electrode active material layers was 3.2 g/cm³. The positive electrode had a thickness of 163 μm and a length of 658 mm. The negative electrode had a length of 700 mm.

(Comparative Battery E)

A positive electrode active material having a composition represented by Li(Ni_{0.1}Mn_{0.5}co_{0.4})_{0.95}Y_{0.05}O₂ was prepared in the same manner as that of the comparative battery B was prepared except that the molar ratio of Ni, Mn and Co contained in the aqueous solution of sulfuric acid salt was changed to 1:5:4. Using this positive electrode active material, a comparative battery E was produced in the same manner as the comparative battery B was produced. In the comparative battery E, the density of the positive electrode active material layers was 3.2 g/cm³. The positive electrode had a thickness of 157 μm and a length of 672 mm. The negative electrode had a length of 714 mm.

(Comparative Battery F)

A hydroxide was prepared in the same manner as that of the comparative battery B was prepared except that the molar ratio of Ni, Mn and Co contained in the aqueous solution of sulfuric acid salt was changed to 1:2:7. A positive electrode active material having a composition represented by LiNi_{0.1}Mn_{0.2}Co_{0.7}O₂ was prepared in the same manner as that of the comparative battery B was prepared except that the obtained hydroxide was mixed with lithium carbonate at a specified ratio, and that Y₂O₃ was not added. Using this positive electrode active material, a comparative battery F was produced in the same manner as the comparative battery B was produced. In the comparative battery F, the density of the positive electrode active material layers was 3.2 g/cm³. The positive electrode had a thickness of 140 μm and a length of 657 mm. The negative electrode had a length of 699 mm.

(Comparative Battery G)

A positive electrode active material having a composition represented by Li(Ni_{0.1}Mn_{0.2}Co_{0.7})_{0.93}Y_{0.07}O₂ was prepared in the same manner as that of the comparative battery F was prepared except that the hydroxide of the comparative battery F was mixed with lithium carbonate and Y₂O₃ at a specified ratio and that Y₂O₃ was added such that the ratio of Y to the total amount of Ni, Co, Mn and Y was 7 mol %. Using this positive electrode active material, a comparative battery G was produced in the same manner as the comparative battery F was produced. In the comparative battery G, the density of the positive electrode active material layers was 3.2 g/cm³. The positive electrode had a thickness of 157 μm and a length of 630 mm. The negative electrode had a length of 672 mm.

(Batteries 1, 17 and 18 and Comparative Batteries H and I)

A positive electrode active material having a composition represented by Li(Ni_{0.1}Mn_{0.2}Co_{0.7})_{0.95}Y_{0.05}O₂ was prepared in the same manner as that of the comparative battery F was prepared except that the hydroxide of the comparative battery F, lithium carbonate and Y₂O₃ were mixed at a specified ratio and that Y₂O₃ was added such that the ratio of Y to the total amount of Ni, Co, Mn and Y was 5 mol %. Using this positive electrode active material, batteries 1, 17, 18, and comparative batteries H and I were produced in the same manner as the comparative battery F was produced. In these batteries, the density of the positive electrode active material layers was 3.2 g/cm³. The positive electrode had a thickness of 141 μm and a length of 657 mm. The negative electrode had a length of 699 mm. As described later, for these batteries, different end-of-charge voltages were used.

(Battery 2)

A positive electrode active material having a composition represented by Li(Ni_{0.5}Mn_{0.2}Co_{0.3})_{0.95}Y_{0.05}O₂ was prepared in the same manner as that of the battery 1 was prepared except that the molar ratio of Ni, Mn and Co contained in the aqueous solution of sulfuric acid salt was changed to 5:2:3. Using this active material, a battery 2 was produced in the same manner as the battery 1 was produced. In the battery 2, the density of the positive electrode active material layers was 3.1 g/cm³. The positive electrode had a thickness of 127 μm and a length of 677 mm. The negative electrode had a length of 719 mm.

(Battery 3)

A positive electrode active material having a composition represented by Li(Ni_{0.1}Mn_{0.4}Co_{0.5})_{0.95}Y_{0.05}O₂ was prepared in the same manner as that of the battery 1 was prepared except that the molar ratio of Ni, Mn and Co contained in the aqueous solution of sulfuric acid salt was changed to 1:4:5. Using this active material, a battery 3 was produced in the same manner as the battery 1 was produced. In the battery 3, the density of the positive electrode active material layers was 3.2 g/cm³. The positive electrode had a thickness of 149 μm and a length of 642 mm. The negative electrode had a length of 684 mm.

(Battery 4)

A positive electrode active material having a composition represented by Li(Ni_{0.5}Mn_{0.4}Co_{0.1})_{0.95}Y_{0.05}O₂ was prepared in the same manner as that of the battery 1 was prepared except that the molar ratio of Ni, Mn and Co contained in the aqueous solution of sulfuric acid salt was changed to 5:4:1. Using this active material, a battery 4 was produced in the same manner as the battery 1 was produced. In the battery 4, the density of the positive electrode active material layers was 3.1 g/cm³. The positive electrode had a thickness of 131 μm and a length of 670 mm. The negative electrode had a length of 712 mm.

(Battery 5)

A positive electrode active material having a composition represented by Li(Ni_{0.1}Mn_{0.2}Co_{0.7})_{0.997}Y_{0.003}O₂ was prepared in the same manner as that of the battery 1 was prepared except that Y₂O₃ was added such that the ratio of Y to the total amount of Ni, Mn, Co and Y was 0.3 mol %. Using this positive electrode active material, a battery 5 was produced in the same manner as the battery 1 was produced.

(Battery 6)

A positive electrode active material having a composition represented by Li(Ni_{0.5}Mn_{0.2}Co_{0.3})_{0.997}Y_{0.003}O₂ was prepared in the same manner as that of the battery 2 was prepared except that Y₂O₃ was added such that the ratio of Y to the total amount of Ni, Mn, Co and Y was 0.3 mol %. Using this positive electrode active material, a battery 6 was produced in the same manner as the battery 2 was produced.

(Battery 7)

A positive electrode active material having a composition represented by Li(Ni_{0.1}Mn_{0.4}Co_{0.5})_{0.997}Y_{0.003}O₂ was prepared in the same manner as that of the battery 3 was prepared except that Y₂O₃ was added such that the ratio of Y to the total amount of Ni, Mn, Co and Y was 0.3 mol %. Using this positive electrode active material, a battery 7 was produced in the same manner as the battery 3 was produced.

(Battery 8)

A positive electrode active material having a composition represented by Li(Ni_{0.5}Mn_{0.4}Co_{0.1})_{0.997}Y_{0.003}O₂ was prepared in the same manner as that of the battery 4 was prepared except that Y₂O₃ was added such that the ratio of Y to the total amount of Ni, Mn, Co and Y was 0.3 mol %. Using this positive electrode active material, a battery 8 was produced in the same manner as the battery 4 was produced.

(Battery 9)

A positive electrode active material having a composition represented by Li(Ni_{0.1}Mn_{0.2}Co_{0.7})_{0.95}Zr_{0.05}O₂ was prepared in the same manner as that of the battery 1 was prepared except that ZrO₂ was used instead of Y₂O₃. Using this positive electrode active material, a battery 9 was produced in the same manner as the battery 1 was produced.

(Battery 10)

A positive electrode active material having a composition represented by Li(Ni_{0.5}Mn_{0.2}Co_{0.3})_{0.95}Zr_{0.05}O₂ was prepared in the same manner as that of the battery 2 was prepared except that ZrO₂ was used instead of Y₂O₃. Using this positive electrode active material, a battery 10 was produced in the same manner as the battery 2 was produced.

(Battery 11)

A positive electrode active material having a composition represented by Li(Ni_{0.1}Mn_{0.4}Co_{0.5})_{0.95}Zr_{0.05}O₂ was prepared in the same manner as that of the battery 3 was prepared except that ZrO₂ was used instead of Y₂O₃. Using this positive electrode active material, a battery 11 was produced in the same manner as the battery 3 was produced.

(Battery 12)

A positive electrode active material having a composition represented by Li(Ni_{0.5}Mn_{0.4}Co_{0.1})_{0.95}Zr_{0.05}O₂ was prepared in the same manner as that of the battery 4 was prepared except that ZrO₂ was used instead of Y₂O₃. Using this positive electrode active material, a battery 12 was produced in the same manner as the battery 4 was produced.

(Battery 13)

A positive electrode active material having a composition represented by Li(Ni_{0.1}Mn_{0.2}Co_{0.7})_{0.95}Mo_{0.05}O₂ was prepared in the same manner as that of the battery 1 was prepared except that MoO₂ was used instead of Y₂O₃. Using this positive electrode active material, a battery 13 was produced in the same manner as the battery 1 was produced.

(Battery 14)

A positive electrode active material having a composition represented by Li(Ni_{0.5}Mn_{0.2}Co_{0.3})_{0.95}Mo_{0.05}O₂ was prepared in the same manner as that of the battery 2 was prepared except that MoO₂ was used instead of Y₂O₃. Using this positive electrode active material, a battery 14 was produced in the same manner as the battery 2 was produced.

(Battery 15)

A positive electrode active material having a composition represented by Li(Ni_{0.1}Mn_{0.4}Co_{0.5})_{0.95}Mo_{0.05}O₂ was prepared in the same manner as that of the battery 3 was prepared except that MoO₂ was used instead of Y₂O₃. Using this positive electrode active material, a battery 15 was produced in the same manner as the battery 3 was produced.

(Battery 16)

A positive electrode active material having a composition represented by Li(Ni_{0.5}Mn_{0.4}Co_{0.1})_{0.95}Mo_{0.05}O₂ was prepared in the same manner as that of the battery 4 was prepared except that MoO₂ was used instead of Y₂O₃. Using this positive electrode active material, a battery 16 was produced in the same manner as the battery 4 was produced.

The batteries produced above were subjected to the following evaluation tests.

[Evaluation]

(Battery Capacity Test)

Each battery was charged at a constant current of 1.8 A in an environment of 25° C. until the battery voltage (end-of-charge voltage) reached 4.4 V. As for the batteries 17 and 18, and the comparative batteries H and I, the end-of-charge voltage was set to 4.25 V, 4.5 V, 4.2 V and 4.6 V, respectively.

Subsequently, the charged battery was charged at the same voltage as the end-of-charge voltage. The total time for the constant current charge and the constant voltage charge was set to three hours.

The charge capacity obtained under the above-described charge conditions for each battery is shown in Table 1 as “battery capacity”.

(Life Characteristic Test)

Each battery was charged under the same conditions as the battery capacity test described above in an environment of 25° C., the battery was then discharged at a constant current of 1.8 A until the battery voltage decreased to 2.75 V. This charge/discharge cycle was repeated 200 times, with an interval of 20 minutes between specified charge/discharge cycles and the subsequent charge/discharge cycles. Then, the rate of discharge capacity at the 200th cycle to discharge capacity at the first cycle (initial discharge capacity) was calculated in percentage. The obtained value for each battery is shown in Table 1 as “capacity retention rate”.

Table 1 also shows the element used as the element L contained in the nickel-containing composite oxide, the molar ratio of a, b, 1−a−b and c in the nickel-containing composite oxide (i.e., values of a, b, 1−a−b and c in the nickel-containing composite oxide), as well as the end-of-charge voltage.

TABLE 1

| | Positive electrode active material | | | | | End-of-charge | Battery | Capacity |
|---|---|---|---|---|---|---|---|---|
| | Li_{d}(NiₐMn_{b}Co_{1-a-b})_{1-c}L_{c}O₂ | | | | | voltage | capacity | retention rate |
| | a | b | 1 − a − b | Element L | c | (V) | (mAh) | (%) |
| Battery 1 | 0.1 | 0.2 | 0.7 | Y | 0.05 | 4.4 | 1960 | 82 |
| Battery 2 | 0.5 | 0.2 | 0.3 | Y | 0.05 | 4.4 | 1984 | 80 |
| Battery 3 | 0.1 | 0.4 | 0.5 | Y | 0.05 | 4.4 | 1923 | 79 |
| Battery 4 | 0.5 | 0.4 | 0.1 | Y | 0.05 | 4.4 | 1949 | 80 |
| Battery 5 | 0.1 | 0.2 | 0.7 | Y | 0.003 | 4.4 | 1962 | 79 |
| Battery 6 | 0.5 | 0.2 | 0.3 | Y | 0.003 | 4.4 | 1987 | 78 |
| Battery 7 | 0.1 | 0.4 | 0.5 | Y | 0.003 | 4.4 | 1927 | 79 |
| Battery 8 | 0.5 | 0.4 | 0.1 | Y | 0.003 | 4.4 | 1950 | 80 |
| Battery 9 | 0.1 | 0.2 | 0.7 | Zr | 0.05 | 4.4 | 1960 | 78 |
| Battery 10 | 0.5 | 0.2 | 0.3 | Zr | 0.05 | 4.4 | 1990 | 79 |
| Battery 11 | 0.1 | 0.4 | 0.5 | Zr | 0.05 | 4.4 | 1922 | 77 |
| Battery 12 | 0.5 | 0.4 | 0.1 | Zr | 0.05 | 4.4 | 1953 | 80 |
| Battery 13 | 0.1 | 0.2 | 0.7 | Mo | 0.05 | 4.4 | 1956 | 76 |
| Battery 14 | 0.5 | 0.2 | 0.3 | Mo | 0.05 | 4.4 | 1985 | 77 |
| Battery 15 | 0.1 | 0.4 | 0.5 | Mo | 0.05 | 4.4 | 1920 | 77 |
| Battery 16 | 0.5 | 0.4 | 0.1 | Mo | 0.05 | 4.4 | 1949 | 78 |
| Battery 17 | 0.1 | 0.2 | 0.7 | Y | 0.05 | 4.25 | 1931 | 87 |
| Battery 18 | 0.1 | 0.2 | 0.7 | Y | 0.05 | 4.5 | 1980 | 75 |
| Comp. Battery A | 0 | 0 | 1 | — | 0 | 4.4 | 2000 | 48 |
| Comp. Battery B | 0.05 | 0.2 | 0.75 | Y | 0.05 | 4.4 | 1904 | 73 |
| Comp. Battery C | 0.55 | 0.2 | 0.25 | Y | 0.05 | 4.4 | 1992 | 66 |
| Comp. Battery D | 0.1 | 0.1 | 0.8 | Y | 0.05 | 4.4 | 1974 | 72 |
| Comp. Battery E | 0.1 | 0.5 | 0.4 | Y | 0.05 | 4.4 | 1864 | 53 |
| Comp. Battery F | 0.1 | 0.2 | 0.7 | — | 0 | 4.4 | 1956 | 42 |
| Comp. Battery G | 0.1 | 0.2 | 0.7 | Y | 0.07 | 4.4 | 1865 | 78 |
| Comp. Battery H | 0.1 | 0.2 | 0.7 | Y | 0.05 | 4.2 | 1902 | 88 |
| Comp. Battery I | 0.1 | 0.2 | 0.7 | Y | 0.05 | 4.6 | 1990 | 41 |

The comparative battery A containing LiCoO₂, a commonly used positive electrode active material, and whose end-of-charge voltage was 4.4 V exhibited a high battery capacity, but its capacity retention rate was extremely low. In the case of comparative battery A, its end-of-charge voltage is usually 4.2 V. In the above tests, however, its end-of-charge voltage was set to 4.4 V. When increasing end-of-charge voltage, the amount of negative electrode active material needs to be increased with increased end-of-charge voltage. However, in the comparative battery A, the amount of negative electrode active material was not increased. Accordingly, it is presumed that lithium not absorbed by the negative electrode active material existed. As a result, the comparative battery A whose end-of-charge voltage was increased to 4.4 V exhibited a high initial battery capacity but very low cycle characteristic.

In contrast, the batteries 1 to 18 containing the nickel-containing composite oxides whose amounts of the element L were adjusted according to the amounts of nickel exhibited excellent outcomes in terms of both battery capacity and capacity retention rate.

The comparative battery B in which the molar ratio “a” of nickel was 0.05 exhibited a small battery capacity. The comparative battery C in which the molar ratio “a” was 0.55 exhibited a small capacity retention rate. The reason why the comparative battery C exhibited a small capacity retention rate is presumably because the irreversible capacity increased.

The comparative battery D in which the molar ratio “b” of manganese was 0.1 exhibited a low capacity retention rate. Presumably, this is because the expansion and contraction of the positive electrode active material was not prevented since the amount of manganese contained in the positive electrode active material was small. The comparative battery E in which the molar ratio “b” was 0.5 exhibited a small battery capacity and a small capacity retention rate. The reason why the capacity retention rate was small is presumably because a large amount of manganese leached out.

The comparative battery F whose positive electrode active material did not contain yttrium (Y) exhibited a low capacity retention rate. This is presumably because the leaching of manganese was not prevented. The comparative battery G in which the molar ratio “c” of yttrium was 0.07 exhibited a low battery capacity. This is presumably because impurities including yttrium remained.

The foregoing results indicate that it is necessary to use a nickel-containing composite oxide represented by the following formula:
Li_{d}(NiₐMn_{b}Co_{1-a-b})_{1-c}L_{c}O₂,
where 0.1≦a≦0.5, 0.2≦b≦0.4, 0.003≦c≦0.05, 1≦d≦1.05, and L is at least one selected from the group consisting of Y, Zr and Mo.

Further, the comparative battery H whose end-of-charge voltage was 4.2 V did not exhibit a sufficiently high capacity. The comparative battery I whose end-of-charge voltage was 4.6 V exhibited an extremely low capacity retention rate. From these results, the end-of-charge voltage is preferably set to 4.25 to 4.50 V to achieve full advantage of the present invention.

### EXAMPLE 2

(Battery 19)

A positive electrode active material having a composition represented by Li(Ni_{1/3}Mn_{1/3}Co_{1/3})_{0.95}Y_{0.05}O₂ was prepared in the same manner as that of the battery 1 was prepared except that the molar ratio of Ni, Mn and Co contained in the aqueous solution of sulfuric acid salt was changed to 1:1:1. Using this positive electrode active material, a battery 19 was produced in the same manner as the battery 1 was produced. In the battery 19, the density of the positive electrode active material layers was 3.2 g/cm³. The positive electrode had a thickness of 136 μm and a length of 661 mm. The negative electrode had a length of 703 mm.

(Battery 20)

A battery 20 was produced in the same manner as the battery 1 was produced except that a mixture prepared by mixing the positive electrode active material of the battery 19 and LiCoO₂ used in the comparative battery A at a weight ratio of 3:7 was used as the positive electrode active material. In the battery 20, the density of the positive electrode active material layers was 3.2 g/cm³. The positive electrode had a thickness of 135 μm and a length of 663 mm. The negative electrode had a length of 705 mm.

(Battery 21)

A battery 21 was produced in the same manner as the battery 20 was produced except that a mixture prepared by mixing the positive electrode active material of the battery 19 and a magnesium-containing composite oxide LiCo_{0.995}Mg_{0.005}O₂ at a weight ratio of 3:7 was used as the positive electrode active material.

LiCo_{0.995}Mg_{0.05}O₂ was prepared in the same manner as LiCoO₂ of the comparative battery A was prepared except that magnesium oxide was added to a mixture of cobalt oxide and lithium carbonate such that the molar ratio of cobalt and magnesium was 0.995:0.005.

(Battery 22)

A battery 22 was produced in the same manner as the battery 20 was produced except that a mixture prepared by mixing the positive electrode active material of the battery 19 and LiCo_{0.9}Mg_{0.1}O₂ at a weight ratio of 3:7 was used as the positive electrode active material.

LiCo_{0.9}Mg_{0.1}O₂ was prepared in the same manner as LiCoO₂ of the comparative battery A was prepared except that magnesium oxide was added to a mixture of cobalt oxide and lithium carbonate such that the molar ratio of cobalt and magnesium was 0.9:0.1.

(Battery 23)

A battery 23 was produced in the same manner as the battery 20 was produced except that a mixture prepared by mixing the positive electrode active material of the battery 19 and LiCo_{0.85}Mg_{0.15}O₂ at a weight ratio of 3:7 was used as the positive electrode active material.

LiCo_{0.85}Mg_{0.15}O₂ was prepared in the same manner as LiCoO₂ of the comparative battery A was prepared except that magnesium oxide was added to a mixture of cobalt oxide and lithium carbonate such that the molar ratio of cobalt and magnesium was 0.85:0.15.

(Batteries 24 to 26)

Batteries 24 to 26 were produced in the same manner as the battery 22 was produced except that the weight ratio of the positive electrode active material of the battery 19 (namely, Li(Ni_{1/3}Mn_{1/3}Co_{1/3})_{0.95}Y_{0.05}O2) and LiCo_{0.995}Mg_{0.005}O₂ was changed to 2.5:7.5, 5:5 and 5.5:4.5, respectively.

The batteries produced above were analyzed for battery capacity and capacity retention rate in the same manner as in EXAMPLE 1. In these tests, the end-of-charge voltage was set to 4.4 V. The results are shown in Table 2. Table 2 also shows the element used as the element L contained in the nickel-containing composite oxide, the molar ratio of a, b, 1−a−b and c (i.e., values of a, b, 1−a−b and c in the nickel-containing composite oxide), and the molar ratio x of magnesium to the total of magnesium and cobalt in the magnesium-containing composite oxide, and the ratio A/(A+B).

TABLE 2

| | Active material (A) | | | | | Active material (B) | | Battery | Capacity |
|---|---|---|---|---|---|---|---|---|---|
| | Li_{d}(NiₐMn_{b}Co_{1-a-b})_{1-c}L_{c}O₂ | | | | | Li_{d}Co₁₋ₓMgₓO₂ | Ratio | capacity | retention rate |
| | a | b | 1 − a − b | Element L | c | x | A/(A + B) | (mAh) | (%) |
| Battery 19 | ⅓ | ⅓ | ⅓ | Y | 0.05 | — | — | 1963 | 81 |
| Battery 20 | ⅓ | ⅓ | ⅓ | Y | 0.05 | 0 | 0.3 | 1976 | 76 |
| Battery 21 | ⅓ | ⅓ | ⅓ | Y | 0.05 | 0.005 | 0.3 | 1974 | 84 |
| Battery 22 | ⅓ | ⅓ | ⅓ | Y | 0.05 | 0.1 | 0.3 | 1971 | 82 |
| Battery 23 | ⅓ | ⅓ | ⅓ | Y | 0.05 | 0.15 | 0.3 | 1936 | 81 |
| Battery 24 | ⅓ | ⅓ | ⅓ | Y | 0.05 | 0.1 | 0.25 | 1928 | 80 |
| Battery 25 | ⅓ | ⅓ | ⅓ | Y | 0.05 | 0.1 | 0.5 | 1980 | 81 |
| Battery 26 | ⅓ | ⅓ | ⅓ | Y | 0.05 | 0.1 | 0.55 | 1935 | 79 |

Comparisons between the battery 19 and the batteries 21, 22 show that the use of a mixture of the nickel-containing composite oxide described above and a manganese-containing composite oxide represented by Li_{d}Co₁₋ₓMgₓO₂, where 0.005≦x≦0.1 and 1≦d≦1.05 increases battery capacity slightly. Although the nickel-containing composite oxide has a low true density, the magnesium-containing composite oxide has a high true density. Accordingly, by using the mixture, the positive electrode capacity can be improved efficiently. However, the battery 20 containing a mixture of the nickel-containing composite oxide and a composite oxide without Mg exhibited a low capacity retention rate. The battery 23 containing the magnesium-containing composite oxide having a large amount of magnesium exhibited a small battery capacity. As the amount of magnesium increases, excess magnesium cannot intercalate into the crystal structure of the active material. This excess magnesium turns into MgO which cannot be involved into charge/discharge reactions. Because the weight of the active material includes the weight of MgO, as the amount of MgO increases, the energy density also decreases. Presumably for this reason, the battery capacity was small.

Comparisons between the batteries 21, 25 and the batteries 24, 26 show that the weight A of the nickel-containing composite oxide and the weight B of the magnesium-containing composite oxide preferably satisfy 0.3≦A/(A+B)≦0.5. The battery 24 in which the amount of the magnesium-containing composite oxide was too large exhibited a low battery capacity. This is presumably because the theoretical capacity of the magnesium-containing composite oxide was smaller than that of the nickel-containing composite oxide. The battery 26 in which the amount of the nickel-containing composite oxide was too large exhibited a small battery capacity. This is presumably because the true density of the nickel-containing composite oxide was smaller than that of the magnesium-containing composite oxide.

According to the present invention, even when the battery capacity is improved by increasing the end-of-charge voltage, it is possible to provide a non-aqueous electrolyte secondary battery having improved life characteristics. Such non-aqueous electrolyte secondary battery can be used as a power source for various applications.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A non-aqueous electrolyte secondary battery comprising a positive electrode including a positive electrode active material, a negative electrode including a negative electrode active material, a separator and a non-aqueous electrolyte,
wherein said positive electrode active material comprises a nickel-containing composite oxide represented by the following formula (1):
Li_{d}(NiₐMn_{b}Co_{1-a-b})_{1-c}L_{c}O₂,
where 0.1≦a≦0.5, 0.2≦b≦0.4, 0.003≦c≦0.05, 1≦d≦1.05, and L is at least one selected from the group consisting of Y, Zr and Mo.

2. The non-aqueous electrolyte secondary battery in accordance with claim 1,
wherein said positive electrode active material further comprises a magnesium-containing composite oxide represented by the following formula (2):
Li_{d}Co₁₋ₓMgₓO₂,
where 0.005≦x≦0.1 and 1≦d≦1.05.

3. The non-aqueous electrolyte secondary battery in accordance with claim 2,
wherein the weight A of said nickel-containing composite oxide and the weight B of said magnesium-containing composite oxide satisfy the following relation:
0.3≦A/(A+B)≦0.5.

4. A system comprising the non-aqueous electrolyte secondary battery in accordance with claim 1 and a charger for charging said non-aqueous electrolyte secondary battery,
wherein the end-of-charge voltage in said charger is set to 4.25 to 4.50 V.
